(19) United States
(12) Patent Application Publication
(10) Pub. No.: US 2006/0219724 A1
(43) Pub. Date: Oct. 5, 2006

(54) Thermos heated from the outside

(76) Inventor: Vladimir Melnik, Brooklyn, NY (US)

Correspondence Address: Vladimir Melnik, 80 Ave. P apt. E14, Brooklyn, NY, 11204, US

(21) Appl. No.: 11/097,760

(22) Filed: Apr. 4, 2005

(51) Int. Cl. A47J 41/00

(52) U.S. Cl. 220/592.27

(57) ABSTRACT

A thermos is disclosed which has been modified so, that its content can be heated while inside the thermos and stays hot for a long time after the external heat source has been removed. The thermos combines properties of a Dewar's vacuum bottle and properties of a heat pipe. It comprises an outer vessel, an inner vessel and a vacuumized space between the vessels. A working substance having a liquid phase and a vapor phase is disposed within the vacuumized space, on the bottom wall of the outer vessel. The amount of the working substance is less than would be necessary to fill the interval between the bottom walls of the vessels. The saturated vapor pressure of the working substance is less then 10 Pa when the outside heat source is removed or turned off. When the thermos is heated, the working substance absorbs heat from the bottom wall of the outer vessel, vaporizes, and delivers the latent heat of vaporization to other parts of the thermos. When the outside source of heat is removed, the device converts to a Dewar's vacuum bottle.

### CROSS-REFERENCE TO RELATED APPLICATIONS

### BACKGROUND OF THE INVENTION

The subject of the present invention is a thermos or vacuum bottle, in particular, a thermos, modified so, that its content can be heated while it is inside the thermos and stays hot for a long time after the external source of heat has been removed or turned off.

A thermos, the content of which can be heated while it is inside the thermos, may be called “heatable thermos”. A thermos of that kind is useful in such applications as:

cooking and frying;

water heaters;

scientific experiments

and in many others.

A heatable thermos can be considered “ideal”, if it is as effective as a metal pot in conducting the heat from an outside heat source to the content, and if it is as effective as a Dewar's thermos in preserving the heat accumulated in the content after the heating process ends.

There are many patents related to heatable thermoses, but up to now, ideal heatable thermos has not been created.

The problem is in conflict between heating and heat preserving. Any means added to a heatable thermos, in order to facilitate the transfer of heat inwards to the content, while the thermos is heated, becomes a means for heat dissipation and outflow from the content of the thermos, after the source of heat has been removed. Therefore, all known heatable thermoses are based on compromises and are far from an ideal.

A typical invention in this field is a “Solar heated vacuum bottle” (U.S. Pat. No. 4,196,721). Heatable thermos of this invention comprises an outer vessel and an inner vessel, together bonding a space exhausted of air. The content of this thermos is heated by solar radiation, reflected inside the thermos by a special jacket. As a means of facilitating transfer of radiation inwards the thermos, the invention uses vessels made of glass transparent to solar radiation. However, after removing or blocking the radiation, transparency becomes a means for rapid heat outflow from the content through transparent vessels to the surroundings.

In “Electrically heated vacuum bottle” (U.S. Pat. No. 4,675,508) the heatable thermos comprises an outer vessel, an inner vessel and an air-free space between the vessels. As a means to bring the heat to the content, the bottom walls of the vessels have apertures, through which an electric heater is inserted. The thermos content receives heat from this heater and therefore the heating is simple. However, this invention does not solve the problem of heat retention. After disconnection of the electric heater, the heat, accumulated in the content, quickly dissipates along the electric wires and through the bottom walls of the vessels. The apertures, which permitted insertion of the electric heating elements, are conduits for the outflow of heat.

Several variations of heatable thermoses with apertures in the bottom walls and with electric heating elements are described in “Vehicle dashboard thermos bottle and utility clamp holder” (U.S. Pat. No. 3,405,899), in “Self-heated bottle” (U.S. Pat. No. 3,549,861), in “Method and apparatus for automatic adiabatic cooking” (U.S. Pat. No. 5,567,458).

These variations have same defects, as the previously cited patents. They do not solve the problem of heat retention.

Patent “Heatable insulated container” (U.S. Pat. No. 5,946,936) offers a different idea. Here, the heatable thermos comprises an outer vessel and an inner vessel, placed into the outer vessel. The space between the lateral walls of these vessels (and this space only) is exhausted of air and has thermal insulating properties. As a means of facilitating the inflow of heat to the content, the bottom walls of both vessels are joined together by bridges having high thermal conductivity. This structure is very suitable for heating. The thermos content can be heated here very efficiently by any source of heat, positioned under the thermos. Still, after removing the source of heat, the collected heat leaves the content through the lower part of the thermos, which, in general, does not have any thermal insulating properties. A special support is designed to reduce the waste of heat through the lower part of the thermos. However, this support can not significantly reduce the outward flow of heat, because the main leak of heat is executed through the outer vessel, which acts as a cooler.

Identical base has a patent “Method and device for transferring heat through a double walled container”. (U.S. Pat. No. 4,629,866). The device comprises an outer wall, an inner wall, a sealed cavity between the walls, and a heat transfer liquid located in the cavity. The heat transfer liquid fills substantially the entire sealed cavity, and a remainder of the cavity includes a vacuum. In other words, said liquid forms a powerful thermal bridge between the walls, along which heat can transfer into and out of the device. Thus, this device has the same defects as the previously cited. Moreover, since the heat transfer liquid is vegetable oil, one cannot asserts, that “the remainder of the cavity includes a vacuum”. Vegetable oil is inconsistent with vacuum, because it evaporates even under room temperature.

The “Cooking utensil and manufacturing method thereof” (U.S. Pat. No. 6,191,393) almost repeats the idea of the two previous patents. Here, short thermal conductive contacts are installed not only between the bottom walls of the vessels, but also between the lateral walls, and the space between the vessels is not exhausted of air. These factors make heat dissipation from the device very intensive.

Patent “Energy efficient cooker” (U.S. Pat. No. 6,305,272 B1) proposed a cooker “capable of preventing loss of heat”.

The cooker consists of:
1) a “main body” assembled of two joined vessels; the space between the vessels is exhausted of air and filled with fluid “affecting a heat transfer”;
2) an “insulation body” which encloses a vacuum space and circumvents the main body, except for the top and the bottom;
3) a “base body” made of two joined vessels with air-free space between the vessels; this body fits on the bottom of the main body;
4) a lid that encloses a vacuum space and fits the top of the main body.

As a whole, the cooker is overly complicated and impractical to manufacture. It contains five sidewalls, four bottom walls, and three vacuum spaces. The nature of the fluid “affecting the heat transfer” in the main body is not disclosed. The cooker does not become a tool for heat retention until the “base body” has been installed. The need for a “base body” is a proof that the “main body” together with the “insulation body” is insufficient to retain the heat. With this understood, it can be seen that “Energy efficient cooker” is a copy of above cited “Heatable insulated container”.

Another attempt to create a heat-retaining device is a “Tea kettle structure” (U.S. Pat. No. 4,026,274). The inventor asserts that one of the purposes of his device is “to retain the heated water therein in a higher temperature for a longer period of time than is otherwise the case” (referring to the action of a common kettle).

This patent contains a bad mistake and the device described in it cannot retain the heated water at a higher temperature for a longer period of time than a common kettle.

It is well known, that the rate of cooling of a body with a determined volume depends on its shape. The body with a minimum rate of cooling is one with the shape of a globe, because it has the smallest surface in relation to the volume enclosed. The body with the maximum rate of cooling is one in the shape of a thin layer.

In “Tea kettle structure”, the body, which is water, is placed in a thin gap between two cylinders, positioned one inside the other. This forces the water into the shape of a thin layer. As a result, the water will cool in such kettle at a rate, which is greater than the same volume of water when poured into a common kettle, which would give it a shape closer to that of a globe. As can be seen, the “Tee kettle structure” claims to defy the principals of physics.

There are a significant number of patents where the problem of heat retention is settled by creation a complex: “cooking pot—Dewar's thermos”. The complex operates in two stages. First stage is cooking food in a regular pot. Second stage is placing this pot with hot food in a thermos. The cooking pot and the thermos are good combined for ease of handling. These complexes are sufficiently intricate and expensive. The main imperfection of such devices consists in impossibility to heat the content directly in thermos and, accordingly, in necessity to have an extra cooking pot. Therefore, they cannot be attributed to heatable thermoses. Information about complexes “cooking pot—Dewar's thermos” can be found, for instance, in U.S. Pat. No. 5,251,542.

As can be seen from the references cited above, in spite of all their merits, none of them has solved the conflict between the requirements of heating the content and the requirements of saving the heat, accumulated in the content of a heatable thermos. Therefore, none of them has proposed an ideal heatable thermos as it was defined above.

Accordingly, a principal purpose of the present invention is a heatable thermos, the characteristics of which are extremely close to ideal.

### SUMMARY OF THE INVENTION

In order to achieve the above-mentioned purpose, the present invention overcomes most of the problems, associated with previously known heatable thermoses. A heatable thermos of the given invention comprises an outer vessel and an inner vessel accommodated inside the outer vessel. Top edges of the vessels are joined together hermetically. The distance between the walls of the vessels is about 0.5-1.5 cm. The space between the vessels is vacuumized to air pressure less then 10 Pa. At this pressure, the mean free path of molecules within the space between the vessels is larger then the distance between the vessels. Under these specifications, the space between the vessels is an excellent thermal insulator. In addition and in contrast to all known heatable thermoses, the present invention uses a special “working substance” positioned on the bottom wall of the outer vessel in the vacuumized space. The working substance meets four requirements.
1. Before the heating process and after the heating process (which means a process of heating the bottom wall of the outer vessel by outside source of heat) the working substance must be in a solid state or in a liquid state; it cannot be in gaseous state.
2. Regardless of the state before or after the heating process (solid or liquid), the working substance must have a liquid phase and a vapor phase during the heating process. This means, for example, that such substances as silver, sodium, mercury, Dowtherm (TM of Dow Chemical Company), vacuum pump fluids and many others can be used as working substances. At the same time, such substances as iodine, red phosphorus, zinc oxide and many others cannot be used as working substances, because they do not have a liquid phase during a heating process.
3. Before the heating process and after the heating process, the saturated vapor pressure of the working substance must be less then 10 Pa. If, for example, the temperature of the outside ambient is a room temperature (which is about 25° C.±10° C.) or less, it means, that silver, sodium, mercury, Dowtherm, vacuum pump fluids and many others substances can be used as working substances. At room temperature, the saturated vapor pressure of such substances is extremely low. Therefore, they do not increase the pressure within the vacuum space of the thermos above 10 Pa, when the outside source of heat is removed. At the same time, such substances as water, vegetable oils, acetone, methanol and many others cannot be used as working substances for a heatable thermos when the ambient temperature is a room temperature. At this temperature saturated vapor pressure of these substances is higher then 10 Pa. However, these substances can be used when the ambient temperature is much lower then the room temperature.
4. The amount of the working substance must be limited so that its volume must be more then zero and less than the volume necessary to fill the interval between the bottom wall of the outer vessel and the bottom wall of the inner vessel. This means, that before heating, there are no thermal bridges between the vessels and the structure resembles the well known Dewar's thermos.

During the heating process, the outside source of heat, placed under the thermos, heats the bottom wall of the outer vessel. The working substance absorbs heat from this wall and vaporizes, taking up the latent heat of vaporization. The vapor rises to the cooler upper parts of the thermos. Here the vapor condenses, giving up the latent heat of vaporization to all parts of the thermos positioned above the heated bottom wall of the outer vessel. The latent heat, received by the bottom and lateral walls of the inner vessel, passes to the content of the thermos and makes it hot. Condensate of the working substance in liquid phase returns by gravitation force to the heated bottom wall of the outer vessel, where it can be vaporized again.

After the outside source of heat is removed, the cooling of the outside vessel begins. The vapor of the working substance condenses, the condensate flows down, and the space between the vessels restores its vacuum and, accordingly, its thermal insulation properties. Through this cooling the heatable thermos converts back to an ordinary Dewar's thermos.

Heat transfer in cycle “vaporization-condensation”, as in the process described above, takes place in thermosiphons and heat pipes. These tools are well known as heat conductors with extremely high effective thermal conductance. But unlike the device being described, thermosiphons and heat pipes are not tools for retention of heat. However, heat pipes specific books is very useful in heatable thermos practice. They contain detailed descriptions of dozens of working substances (see, for example, “Heat pipe. Science and technology”, by Amir Fighri; “Heat Pipes”, by P. D. Dunn).

### BRIEF DESCRIPTION OF THE DRAWINGS

FIG. 1 represents a selected longitudinal axial section of a preferred embodiment of a heatable thermos in accordance with the present invention. The thermos in this figure is not in process of being heated by an outside source of heat.

FIG. 2 represents a selected longitudinal axial section of a preferred embodiment of a heatable thermos in accordance with the present invention. The thermos in this figure is in process of being heated.

FIGS. 3-5 represent views of some auxiliary elements.

FIG. 6 is a perspective view of an inner vessel.

FIG. 7 is a perspective view of an outer vessel with welded nipple and bracket.

FIG. 8 is a perspective view of the heatable thermos at the final stage of assembly.

The foregoing description of the invention and the description of the drawings of the preferred embodiment of the invention have been presented for the purpose of illustration. It is not intended that the scope of the invention be limited by these descriptions but rather by the claims appended hereto.

### DETAILED DESCRIPTION OF THE PREFERED EMBODIMENT

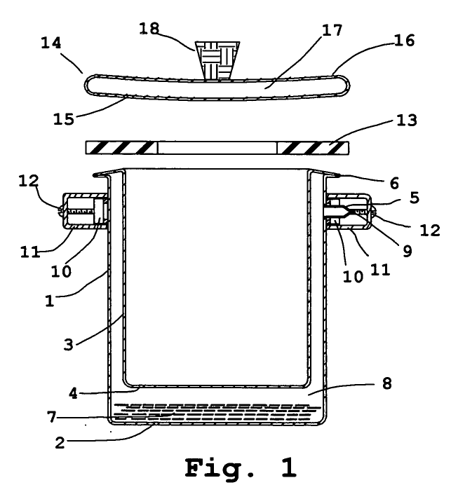

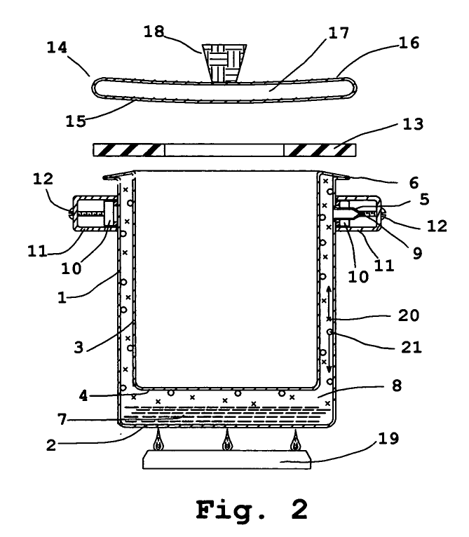

The essence of the present invention becomes evident through a careful examination of FIG. 1 and FIG. 2.

FIG. 1 represents a heatable thermos when the outside source of heat is absent. FIG. 2 represents the same heatable thermos while it is being heated by an outside source of heat.

Others figures (from number 3 to number 8) submitted for consideration are less important. They relate mostly to auxiliary parts and to details of assembly.

Refer now to FIG. 1. The heatable thermos includes an outer vessel, which consists of a lateral wall 1 and a bottom wall 2, and an inner vessel, which consists of a lateral wall 3 and a bottom wall 4.

The inner vessel is accommodated inside the outer vessel and serves as a receptacle for the thermos content.

Both vessels are made of metal (preferably of stainless steel).

A tubular nipple 5 is welded to the lateral wall 1 on the upper part of this wall.

Top edges of the lateral walls of both vessels are joined together hermetically by welding and the line 6 is a corresponding welding seam. This process at the same time makes up a circular mouth opening of the thermos.

By using nipple 5, a working substance 7 (for example, Dowtherm) is inserted into the space 8, which is between the vessels. After insertion, the working substance becomes positioned on the bottom wall 2. To meet the requirements, stated in “SUMMARY”, the amount of the working substance is about ½ of what is necessary to fill the distance between the walls 2 and 4, so as not to provide a means for direct heat transfer between these walls when the outside source of heat is absent.

By using nipple 5 again, the space 8 is vacuumized to the air pressure less then 10 Pa, in order to form a thermal insulating layer between the vessels. Then the nipple 5 is squeezed closed and welded along line 9.

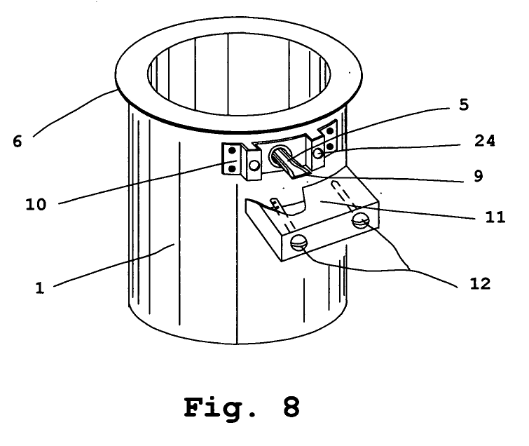

Elements 10, 11, and 12 are units of a handle for the thermos and they will be described in FIG. 4, FIG. 5, FIG. 7 and FIG. 8.

A lid 14, shown on FIG. 1, comprises a bottom plate 15, a top plate 16, a space between these plates 17 and a handle 18. Both plates made of metal and joined together hermetically. Space 17 is filled up with a thermal insulator. It can be, for example, vacuum, silica aerogel, dolomite wool and so on. Plate 15 has a shape of a spherical segment with a big radius of curvature. The spherical shape of the bottom plate of the lid and the circular shape of the mouth opening of the thermos are superposed ideally. Accordingly, the described lid closes the mouth opening of the thermos extremely tightly. An elastic gasket 13 is placed between the mouth opening of the thermos, and the lid. The gasket levels the errors of making the mouth opening and the lid.

As one can see, the heatable thermos depicted in FIG. 1 is an ordinary Dewar's thermos, where the outer vessel and the inner vessel are separated by a vacuumized space all over, except where the necks are attached to one another.

FIG. 2 shows the same thermos being heated by an outside source of heat. FIG. 2 is distinguished from FIG. 1 by the presence of three objects.

The first object is the outside source of heat 19.

The second object is the vapor of working substance designated by number 20, which represents all the molecules of this vapor. Signs “x” indicate the molecules.

The third object is the flow of the condensate of the working substance designated by number 21. This flow in different parts of the thermos indicated by signs “o”.

The working substance 7 absorbs heat from the bottom wall 2, which is the wall heated by the outside source of heat. Molecules of the working substance rise up to the cooler parts of the thermos (as indicated by the upward pointing arrow). On reaching the cooler parts, the molecules transfer their latent heat of vaporization to these parts, and condense. Condensate falls down (as indicated by the downward pointing arrow) to bottom wall 2, where it takes part in the next cycle of heating, evaporation, and condensation. The heat energy transferred to walls 3 and 4, is conducted through them and causes the heating of the content of the thermos.

After the heating of the content is complete and the outside heat source 19 is removed or shut off, the wall 2 cools down by the surroundings, vaporization stops, and FIG. 2 transforms to FIG. 1, which is an ordinary Dewar's thermos. Accordingly, the content of the thermos, disposed in the inside vessel stays hot just as long, as in the case of a Dewar's thermos.

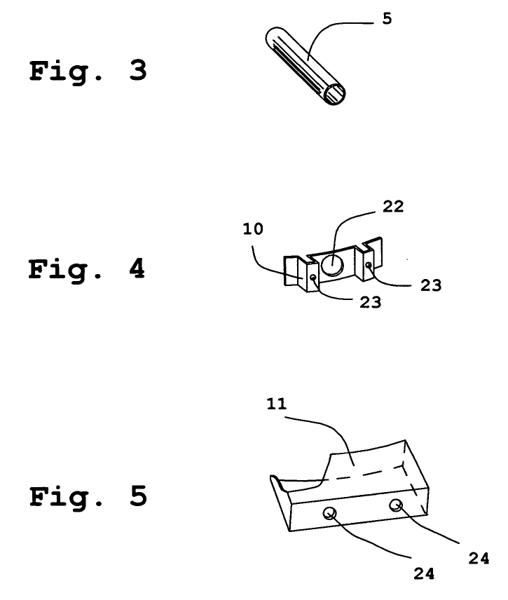

FIG. 3 represents a tubular nipple 5. It is made of stainless steel, and was previously mentioned in connection with FIG. 1, as being used to insert the working substance between the outer and inner vessels and to vacuumize the space between the vessels.

FIG. 4 is a stainless steel brace 10. It has a hole 22 in the centre and two side holes 23 with internal threads.

Element 11 on FIG. 5 is a hollow handle. It has two holes 24 for receiving screws. The distance between holes 24 is the same as between holes 23 within the brace 10.

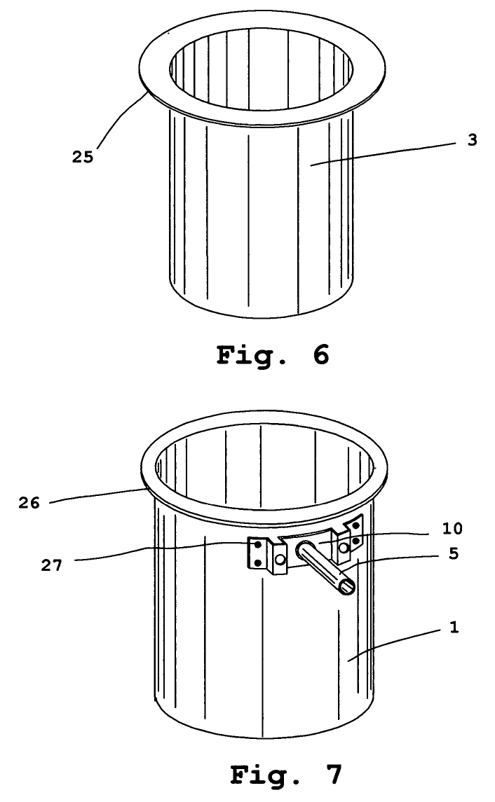

FIG. 6 shows the inner vessel before it has been accommodated inside the outer vessel. The inner vessel has a shape of a circular cylinder. Lateral wall 3 terminates in a top edge 25.

FIG. 7 shows the outer vessel before the inner vessel was inserted. The tubular nipple 5 is welded to the lateral wall 1. The brace 10 is welded to the wall 1 at four welding points 27. An equivalent brace has been fastened to the opposite side of the vessel (not visible in FIG. 7). The wall 1 terminates in a top edge 26.

FIG. 8 is a perspective view of almost assembled thermos. The inner vessel has been accommodated inside the outer vessel and the top edges 25 and 26 have been joined together hermetically by welding. Round line 6 is the seam of this weld. By means of the nipple 5, the working substance has been inserted into the space between the vessels and this space has been vacuumized. Then nipple 5 was squeezed and welded along line 9. Handle 11 is ready to be attached to the brace 10 by screws 12. After attachment, the handle will cover the fragile nipple 5. An equivalent handle has been attached on the opposite side of the thermos (not visible in the figure).

The heatable thermos described above has a lot of merits. Some of the merits will be explained through examples.

### EXAMPLE 1

Cooking Process

In a cooking process, which takes place in a single walled pot, a certain food requires an external heat source to be applied for a certain length of time. The same food, when cooked in the heatable thermos will require less time, because the heat trapped in the food will continue the cooking process after the heat source has been removed. Cautious estimate shows that energy saving in a cooking process, when it is executed in a heatable thermos instead of a pot, can reach 25-50%.

A heatable thermos in this example was made of stainless still a 0.03 cm thick. The diameter of the inner vessel was 16 cm and the height-22 cm. The distance between the lateral walls of this thermos was 0.6 cm; between bottom walls-1.5 cm. Fluid “Dowtherm A” was chosen as working substance and its volume was 150 ml. Such quantity of substance filled up the space between the bottom walls nearly in half. A gas-stove has been used as a source of heat. Experiment was made by cooking 1 kg of potatoes in water. After 8 minutes of heating, the stove was turned off. During the next 9 minutes, the cooking was completed. Energy saving in this case exceeded 45%.

Another source of saving energy is the lid. Such tightly fitted lid, as described above, makes it possible to keep food after cooking without refrigeration. The food is sterilized in cooking process. After cooking, the lid, pressed down by outside atmospheric pressure, makes it impossible for microbes to penetrate into the thermos. Therefore, the food contained within the heatable thermos can stay fresh for many days without refrigeration, until the seal of the lid is broken.

Saving of energy and food preserving, obtained with a heatable thermos, especially important in areas with extreme weather conditions, like geographical pole or deserts.

### EXAMPLE 2

Water Heater

Heatable thermos can be used as an excellent water heater of a storage type. A simple and widely used water heater of this type is the gas-fired heater. It consists of a water tank, cold water inlet, hot water outlet, gas supply controller, gas burner and vent. Advantages of the heatable thermos become apparent in two phases of operation of such water heater.

First phase is the “working phase”, when there is incoming cold water and there is out coming hot water. In a common heater, only the bottom wall of the tank is heated during the heating process, and so the energy factor of a gas-fired water heater is low-around 0.5. In a heatable thermos case, both walls of the inner vessel (bottom and lateral) are heated during the heating process. Therefore, the time of heating water to a certain temperature and, accordingly, fuel consumption is less in heatable thermos then in a common heater.

Second phase is the “silent phase”, when it is no incoming cold water, no out coming hot water and the burner switches on and off to hold the water in the tank in a stated temperature interval. The thermal insulation of a heatable thermos is almost absolute and is much better than thermal insulation of a common water heater. Therefore, the burner will switch on and off much rare in heatable thermos then in a common water heater. Moreover, the position “on” for the burner will be shorter and position “off” will be longer in heatable thermos case then in a common case. This is a second source of fuel saving.

1. A thermos heated from the outside, comprising:
(a) an outer vessel having a lateral wall with a top edge, and a bottom wall, which is the part of the thermos to receive heat from an outside source of heat during a heating process;
(b) an inner vessel, accommodated inside said outer vessel, and having a lateral wall with a top edge, and a bottom wall; said top edge of said outer vessel and said top edge of said inner vessel joined together hermetically to form a thermos mouth opening and to form a space between said vessels; said space between said vessels is vacuumized to an air pressure lower than 10 Pa to form a thermal insulating layer between said vessels;
(c) a working substance positioned on said bottom wall of said outer vessel within said vacuumized space between the vessels; said working substance is capable of absorbing heat from said bottom wall of said outer vessel during the heating process and delivering heat to all other walls of said thermos in three steps: evaporation, condensation, and return in liquid phase to said bottom wall of said outer vessel; the amount of said working substance is less then would be necessary to fill the interval between said bottom wall of said outer vessel and said bottom wall of said inner vessel; saturated vapor pressure of said working substance is less than 10 Pa when the outside source of heat is turned off or removed;
(d) a thermal insulating lid which forms an air tight barrier when placed on said thermos mouth opening.
